(19) United States
(12) Patent Application Publication
(10) Pub. No.: US 2011/0068894 A1
(43) Pub. Date: Mar. 24, 2011

(54) METHOD FOR AUTHENTICATING AN RFID TAG

(76) Inventor: Michael Braun, Munchen (DE)

(21) Appl. No.: 12/992,286

(22) PCT Filed: Apr. 16, 2009
(86) PCT No.: PCT/EP09/54531

§ 371 Date: Nov. 12, 2010

(30) Foreign Application Priority Data
May 16, 2008 (DE) 10 2008 023 914.3

(51) Int. Cl. G05B 19/00

(52) U.S. Cl. 340/5.8

(57) ABSTRACT

To ensure data protection in an authentication method for use in an RFID system in accordance with the challenge-response protocol, the data communication between RFID reader and RFID tag is usually encrypted in addition. Such an authentication can be designed to an arbitrary degree of complexity and therefore inevitably requires a high level of investment in hardware and software resources. An RFID tag has a display, wherein the response is displayed on the display of the RFID tag and is read in by the RFID reader by an optical scanner. The response of the RFID tag can therefore be read out only when there is direct visual contact.

### CROSS-REFERENCE TO RELATED APPLICATIONS

This application is a U.S. National Stage Application of International Application No. PCT/EP2009/054531 filed Apr. 16, 2009, which designates the United States of America, and claims priority to DE Application No. 10 2008 023 914.3 filed May 16, 2008. The contents of which are hereby incorporated by reference in their entirety.

### TECHNICAL FIELD

The invention relates to a system and a method for authenticating an RFID (Radio Frequency Identification) tag, in particular for authenticating RFID tags in a way that guarantees data protection.

### BACKGROUND

RFID (Radio Frequency Identification) enables labels or, more precisely, tags to be fitted with a chip that can be read contactlessly. RFID tags are employed primarily for identifying goods. Pieces of identification used for access control and in payment systems can also be provided with RFID tags. A distinction is made between active and passive RFID tags. Active RFID tags possess an independent dedicated power supply, whereas passive RFID tags have no dedicated power supply of their own. Passive RFID tags are supplied with energy by means of an electromagnetic field broadcast by an RFID reader.

Typically, an RFID tag has a data memory having a plurality of addressable memory units. The RFID reader provided for reading out the data stored on the RFID tag has a predefined standard command set for accessing the memory units of the RFID tag. Data stored on the memory RFID tag can be read out or, as the case may be, data can be written to the tag by means of the two commands “Read” and “Write”, respectively. With these conventional RFID tags it is only possible to write data into a data memory of the RFID tag or read data out of the data memory.

Increasingly, however, sensitive data is also made available on an RFID tag, such as in electronic passports, access control cards or in IPR protection applications, for example. For data protection and security reasons it is essential to prevent unauthorized reading of the data from such an RFID tag. In the case of RFID tags, in contrast to data media having contact interfaces, the data is transmitted wirelessly, so there is the risk in particular that data will be read out unnoticed.

A distinction is made here between the following two categories of protection and consequently security against interception:

### 1. Protection of Private Data (Data Privacy):

An essential requirement in order to ensure protection for private data is that by eavesdropping on the data communication between RFID reader and transponder, or alternatively also by actively addressing the transponder, an unauthorized user must not be able to deduce the device's identity. Otherwise said unauthorized user would obtain security-critical, sensitive data that is stored e.g. on the transponder. Such sensitive data can contain e.g. user-specific information.

### 2. Protection of the Local Private Sphere (Location Privacy):

In order to safeguard the local private sphere it is essential to prevent an unauthorized user from being able to obtain location-based information about the transponder by eavesdropping on the data communication between RFID reader and transponder or else by, for instance, actively addressing the transponder at two different instants in time. In particular it must therefore be ensured that an unauthorized user cannot derive therefrom that it is in each case the same transponder or, for instance, even different transponders, since otherwise he/she can derive so-called movement profiles (tracking) of individual transponders and consequently also of their users. Here too what is at stake is security-critical, sensitive information that it is imperative to protect.

By means of access control mechanisms it is therefore ensured that unauthorized reading of the data from the RF chip as well as eavesdropping on the communication are prevented. Protection of said kind is achieved for example through encryption of the stored data.

A further important security measure is the mutual authentication of RFID tag and reader in order to avoid an unauthorized user (or attacker) coupling into the data communication unnoticed and consequently being able to read out security-critical data. Furthermore it can be guaranteed in this way that the read data originates from an RFID tag that has not been tampered with.

In order to verify authenticity an authentication function is implemented by means of a so-called challenge-response method, for example. In such a challenge-response method a random “challenge” is generated by the RFID reader for the purpose of authenticating the RFID tag and sent to the RFID tag. For its part the RFID tag computes the “response” belonging to said “challenge” using a secret key and sends said “response” back to the RFID reader. The RFID reader then checks the response received from the RFID tag to verify its correctness. The challenge-response protocol is designed in such a way that only the RFID tag that possesses the right secret key can compute the correct response. It is also not possible for an attacker to ascertain the secret key through knowledge of pairs consisting of the challenge and the associated valid response.

In order to guarantee data protection for a method of said kind the data communication between reader and RFID tag is additionally encrypted. Such an authentication can be designed to an arbitrary degree of complexity. That said, however, an important boundary condition in RFID-based data communications is that data communication between RFID reader and transponder should take place in the simplest and most expeditious manner possible. The reason for this is that on the one hand the transponder typically possesses only limited resources, i.e. firstly limited energy resources and secondly limited memory and computing resources, with the result that during the authentication typically the smallest possible volumes of data should be evaluated and authenticated. On the other hand said authentication should also be completed as rapidly as possible since particularly in the case of dynamic RFID-based data communication systems the transponder requiring authentication is very often located within the range of action of the respective RFID reader only for a short period of time. Within said short time period it is necessary firstly for a data communication link to be set up and authenticated, and then for the exchange of data to take place. However, the known prior art solutions necessitate a relatively large hardware overhead due to the computationally intensive encryption on the RFID tag side.

### SUMMARY

Against this background, according to various embodiments, an authentication method and system for an RFID communication system or in an RFID communication system can be provided which on the one hand provides the highest possible level of security and on the other hand requires the lowest possible hardware overhead in order to achieve this purpose.

According to an embodiment, a method for authenticating at least one RFID (Radio Frequency Identification) tag by means of an RFID reader using a challenge-response protocol may comprise the steps of: (a) generating a challenge by means of the RFID reader, (b) wirelessly transmitting the challenge to the RFID tag, (c) computing a response by means of the RFID tag on the basis of the transmitted challenge and a first secret key that is assigned to the RFID tag, wherein (d) the computed response is displayed on a display of the RFID tag, (e) the displayed response is automatically read in and checked by the RFID reader.

According to a further embodiment, the computed response can be displayed in encrypted form on the display. According to a further embodiment, the computed response can be displayed as a barcode on the display. According to a further embodiment, a symmetric cryptographic method in which the RFID reader possesses the first secret key can be used for the challenge-response protocol. According to a further embodiment, an asymmetric cryptographic method may having an asymmetric key pair consisting of a private and a public key can be used for the challenge-response protocol, wherein the private key is known only to the RFID tag. According to a further embodiment, the RFID reader may possess the public key of the asymmetric key pair. According to a further embodiment, the public key can be transmitted to the RFID reader in a certificate that is assigned to the RFID tag. According to a further embodiment, the certificate transmitted by the RFID tag can be checked by the RFID reader in order to verify its validity, and the check on the validity of the certificate can be performed using a further public key. According to a further embodiment, the asymmetric cryptographic method can be implemented on the basis of scalar multiplications on a suitable elliptic curve.

According to another embodiment, a system for authenticating an RFID (Radio Frequency Identification) tag by means of an RFID reader in accordance with a challenge-response protocol, may comprise: (a) an RFID reader which has a first authentication module for generating a challenge and for checking a received response, and which has a first communication module for wirelessly transmitting the challenge, (b) at least one RFID tag, having a second communication module for receiving the transmitted challenge and a second authentication module which computes the response associated with the received challenge, wherein the RFID tag has a display on which the computed response is displayed and the RFID reader has an optical reading module by means of which the displayed response is automatically read in.

According to a further embodiment of the system, the RFID tag together with associated display can be operated passively. According to a further embodiment of the system, the first and second authentication module may have a computing module which is provided for performing calculations, checks and authentications within the respective authentication module. According to a further embodiment of the system, the first and second authentication module may have an encryption/decryption device which is provided for performing a respective encryption and/or decryption.

### BRIEF DESCRIPTION OF THE DRAWINGS

The invention is explained in more detail with the aid of exemplary embodiments and with reference to the figures, in which:

FIG. 1 is a block diagram of an RFID system,

FIG. 2 shows a schematic representation of the authentication method, and

FIG. 3 is a flowchart serving to illustrate the authentication method implemented on the basis of elliptic curves.

### DETAILED DESCRIPTION

According to various embodiments, a method for authenticating at least one RFID (Radio Frequency Identification) tag by means of an RFID reader using a challenge-response protocol may comprise the following steps:

(a) generating a challenge by means of the RFID reader,
(b) wirelessly transmitting the challenge to the RFID tag,
(c) computing a response by means of the RFID tag on the basis of the transmitted challenge and a first secret key,
(d) displaying the computed response on a display of the RFID tag,
(e) automatic reading of the displayed response by the RFID reader and checking of the read-in response.

The system according to various embodiments for authenticating an RFID (Radio Frequency Identification) tag by means of an RFID reader in accordance with a challenge-response protocol may comprise:

(a) an RFID reader which has a first authentication module for generating a challenge and for checking a received response, and which has a first communication module for wirelessly transmitting the challenge,
(b) at least one RFID tag having a second communication module for receiving the transmitted challenge and a second authentication module which computes the response associated with the received challenge, wherein
the RFID tag has a display on which the computed response is displayed and
the RFID reader having an optical reading module by means of which the displayed response is automatically read in.

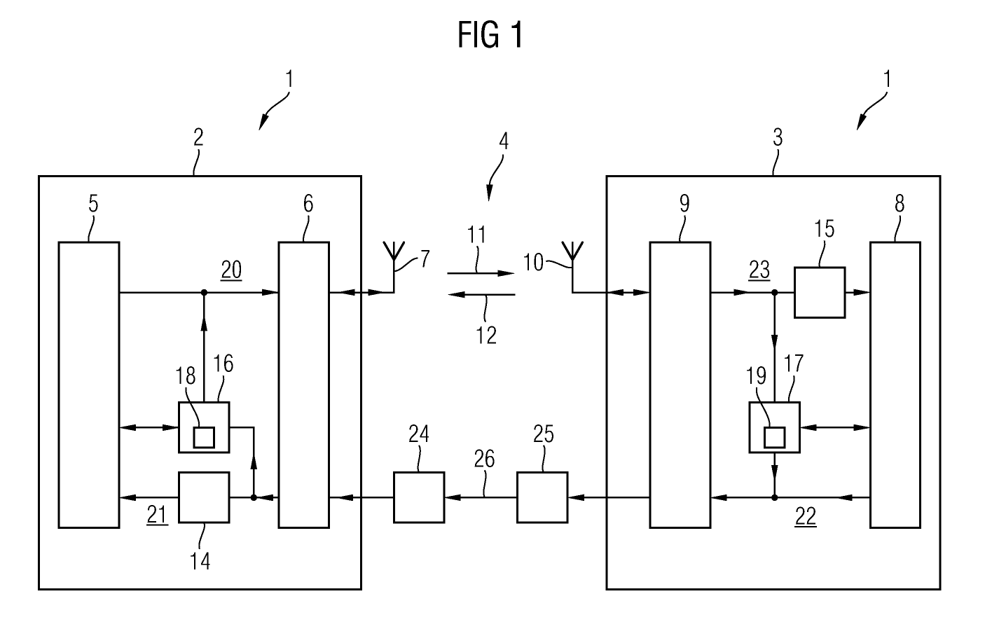

Firstly, the basic layout of an RFID system according to various embodiments is explained in more detail with reference to the block diagram shown in FIG. 1.

In FIG. 1, an RFID system is labeled with reference numeral 1. The RFID system 1 contains an RFID reader 2 and an RFID transponder 3. A bidirectional communicative connection exists between RFID reader 2 and RFID transponder 3 by way of a wireless communication link 4.

The RFID reader 2 comprises a control device 5, a transmitting/receiving device 6, and a transmit/receive antenna 7. In the same way the RFID transponder also comprises a control device 8, a transmitting/receiving device 9, and a common transmit/receive antenna 10.

The transmit/receive antennas 7, 10 can be embodied as inductive coil antennas or also as dipole antennas.

The flow sequence of the data communication is controlled in the respective control devices 5, 8. Typically, said control device contains a computing device (arithmetic logic unit, CPU or the like) in which the computational operations, in particular for the authentication, are carried out.

The data communication is controlled in each case by way of the RFID reader-side control device 5 and the transponder-side control device 8. The control device 5 of the RFID reader 2 is configured for sending high-frequency carrier signals 11 via the antenna 7 to the antenna 10 of the transponder 3. In the same way the control device 8 and the transmitting/receiving device 9 of the transponder 3 are configured for sending corresponding response signals 12 back to the RFID reader 2 in response to the sent carrier signals 11. The control devices 5, 8 can be embodied, for example, as program-controlled devices, such as e.g. microcontrollers or microprocessors, or else be implemented in hardwired logic circuitry, such as e.g. as FPGAs or PLDs.

The memories 18, 19 typically contain a RAM memory in which e.g. results of computations are stored. In addition or alternatively, said memory 18, 19 can also have an EEPROM memory in which system parameters, parameters of the different communication users, such as e.g. a user-specific private key, a public key, a user-specific certificate or the like, are stored.

The RFID reader 2 also has an evaluation device 14. Said evaluation device 14 is disposed in the receive path of the RFID reader 2 and connected downstream of the receiver of the transmitting/receiving device 6. In the same way the transponder 3 also has an evaluation device 15 in the receive path 23 of the transponder 3. The data received during a data communication is evaluated in the respective evaluation devices 14, 15. In particular the received data is demodulated and decoded in said devices.

In addition, both the RFID reader 2 and the transponder 3 have an authentication module 16, 17 which are disposed between the respective transmitting/receiving device 6, 9 and control device 5, 8 of the RFID reader 2 and of the transponder 3, respectively. In the present case said authentication modules 16, 17 are embodied as separate modules. Preferably, however, said authentication module 16, 17 is a constituent part of the respective control device 5, 8.

An authentication module 16, 17 also has a memory 18, 19 in which are stored, for example, data, keys or the like which are required for the authentication or need to be buffered.

According to various embodiments the RFID transponder now has a display 25 which is configured for displaying data transmitted by the transmitting/receiving device 9 of the transponder 3. This is in particular a response computed in the course of a challenge-response method used for authentication purposes. The response can be displayed encrypted, unencrypted or as a barcode, for example. It goes without saying that other data can also be visualized by way of the display 25. According to various embodiments the RFID reading device 2 has an optical reader 24 for the purpose of automatically reading in the data presented on the display 25. The optical reader is embodied as a (barcode) scanner or camera, for example.

An RFID tag together with display of said type has been developed within the scope of the PARIFLEX project funded by the German Federal Ministry for Research and Technology (see: http://www.vue.fraunhofer.de/index.php?id=319). In addition to the usual components of RFID tags the so-called D-RFID includes a display, enabling the presented data to be read from the RFID tag by a human being when there is visual contact. The bistable display, just like the RFID tag itself, is operated passively. In other words it is supplied with electric current by the RFID reader and therefore requires no independent power supply source of its own.

In the first stage of the EU passport project use is being made of a method in which only someone who also actually has optical access to the passport can read out the contents of the data memory (see: http://www.bsi.bund.de/fachthem/epass/Sicherheitsmerkmale.pdf). Technically, this is implemented in such a way that the reader is required to authenticate itself to the RFID chip. For said authentication the reader needs a secret access key which is calculated from the machine-readable zone of the passport. Therefore the reader must first optically read the machine-readable zone, calculate the access key therefrom, and only then can it authenticate itself to the RF chip.

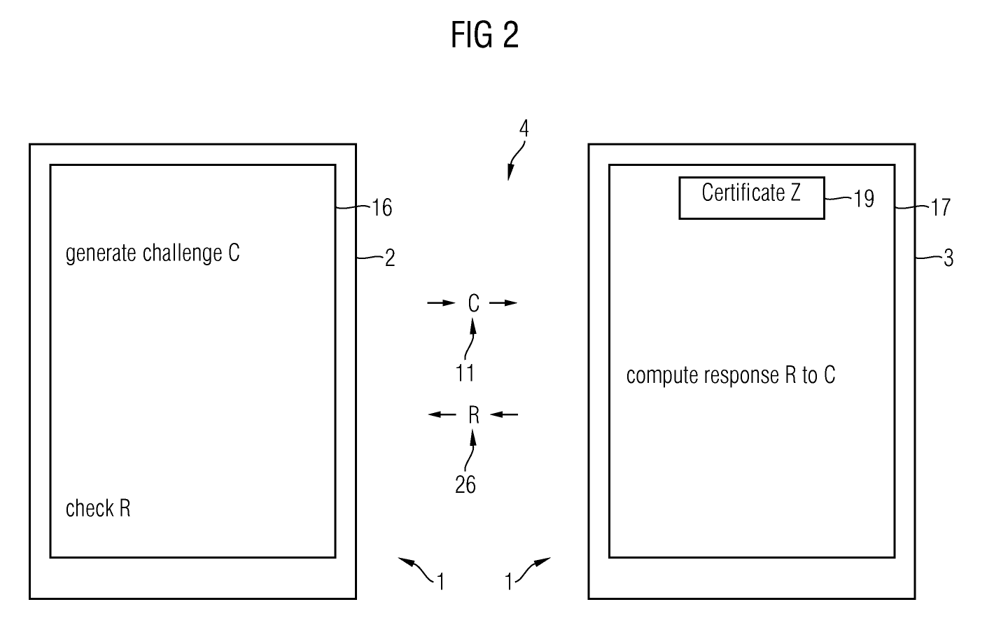

FIG. 2 shows a schematic representation of the RFID reader 2 and the RFID transponder 3 of the RFID system 1, with only the authentication modules 16, 17 contained within said devices 2, 3 being shown therein for the purpose of explaining the authentication method.

The authentication method according to various embodiments takes place as follows:
At the start of the authentication method the authentication module 16 on the RFID reader side generates a challenge C.
The authentication module 16 transmits said challenge C as a challenge signal 11. One or more transponders 3 located in the immediate vicinity of said RFID reader 2 pick up said challenge signal 11 containing the challenge C, with said challenge signal 11 being demodulated and decoded in the respective transponder 3 in a known manner.
Next, the authentication module 17 computes the response R matching the challenge C.
The authentication module 17 then sends the response R as a response signal to the display 25, on which the response R is displayed in an optically visible manner.
The RFID reader 2 reads in the data presented on the display 25 by means of an optical scanner 24. In the RFID reader 2, and in particular in the authentication module 16 disposed therein, the read-in response signal 26, which contains the response R, is processed, with the result that the response R is now also present in the authentication module 16.
The authentication module 16 checks the response R. If the result of the check on said data R is positive the transponder 3 is authenticated vis-à-vis the RFID reader 2, so directly thereafter the actual data communication can take place between the RFID reader 2 and the transponder 3 by way of the wireless bidirectional communication link 4.

The above-described method is suitable in principle for symmetric and asymmetric authentication methods. In the case of a symmetric authentication method both the RFID reader and the RFID transponder have the same secret key. In the case of an asymmetric authentication method there exists an asymmetric key pair consisting of a private and a public key. The private, secret key is known only to the RFID transponder.

Generally there are two ways in which the public key can be made known to the RFID reader. The first possibility is that the public key is already known to the RFID reader. With the second possibility the public key is incorporated into a certificate that is assigned to the RFID transponder and transmitted by the latter together with the response R to the RFID reader.

According to the second possibility, the transponder 3 authenticates itself to the RFID reader 2 by sending back to the RFID reader 2 a valid certificate Z′ together with a valid response R in answer to the challenge C sent by the RFID reader 2. The transponder 3 can compute and return such a valid response R only if it has knowledge of the secret key ξ_{T} of the transponder belonging to the public key x_{T} from the certificate Z′. In order in turn to verify the certificate Z′ the RFID reader can use a public signature key x_{S} of the authority that issued the certificate Z′.

For this exemplary embodiment it is assumed that the RFID reader generates the challenge C independently of the secret key stored in the transponder 3. Otherwise an additional communication step, for example, would be necessary so that the transponder 3 can first communicate its identity or its public key to the RFID reader 2. This makes the authentication method shorter overall.

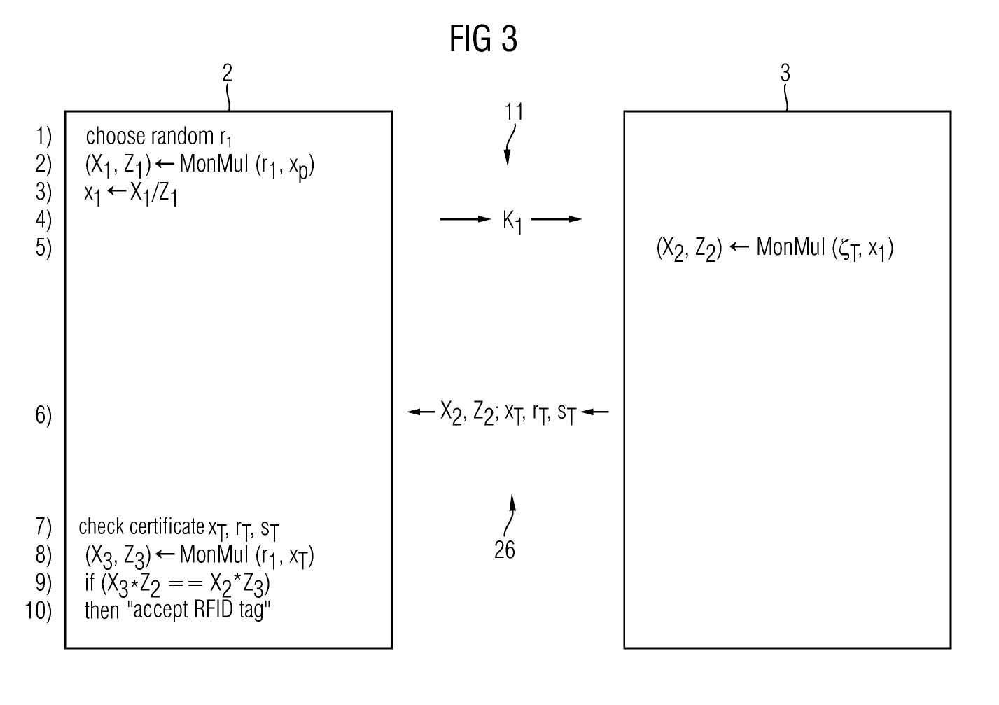

The authentication method shown by way of example in FIG. 3 is performed as follows:

In steps 1) to 4) of the authentication protocol shown in FIG. 5 according to various embodiments, the RFID reader generates the challenge C=x_{T1}. Said challenge x₁ represents the x coordinate of the point P₁=r₁*P for a random scalar r₁. The RFID reader 3 sends this challenge x₁ to the transponder 3.

A response is computed in step 5). In this step the transponder 3 computes the corresponding response (X₂,Z₂) in answer to the challenge x₁, which response represents the projective x coordinate of the point

P₂=ξ_{T}*P₁=ξ_{T}*(r₁*P).

In step 6), the transponder 3 transmits the response (X₂,Z₂) together with its certificate Z′ of the transponder 3 to the RFID reader. The certificate Z′ in this case consists of the public key x_{T} of the transponder 3 and the signature components r_{T} and s_{T}.

For the transmission the data ((X₂, Z₂), Z′) is displayed on the display 25 in machine-readable form. Said displayed information is read in by means of the optical reader 24 of the RFID reader 2.

The RFID reader 2 checks the certificate Z′ of the transponder 3 in step 7). If the certificate Z′ is not valid, the RFID reader 2 rejects the transponder 3 as not authentic.

In steps 8)-9), the RFID reader 2 checks the response of the transponder 3. The RFID reader 2 computes the projective x coordinate (X₃,Z₃) of the point P₃=r₁*T=r₁*(ξ_{T}*P) and in the process checks whether (X₂,Z₂) and (X₃,Z₃) can be projective coordinates of the same point. This is precisely the case when X₃Z₂=X₂Z₃ applies. If the response is correct, the transponder 3 is authentic (step 10)). If the response is incorrect, the RFID reader 2 rejects the transponder 3 as not authentic.

The protocol described permits very simple and nonetheless very reliable authentication, as well as a maximum degree of privacy protection (data and location privacy).

The various embodiments described enable the response to be read out in a challenge-response method only when direct visual contact exists to the display of the RFID transponder. Unnoticed reading of the RFID tag is therefore excluded. A further advantage achieved by means of various embodiments is that no encryption of the data communication is necessary during an authentication in order to ensure data protection. This leads to a considerable simplification in terms of the hardware and software requirements for the RFID tag.

What is claimed is:

1. A method for authenticating at least one Radio Frequency Identification (RFID) tag by means of an RFID reader using a challenge-response protocol comprising the steps of:
(a) generating a challenge by means of the RFID reader,
(b) wirelessly transmitting the challenge to the RFID tag,
(c) computing a response by means of the RFID tag on the basis of the transmitted challenge and a first secret key that is assigned to the RFID tag,
(d) displaying the computed response on a display of the RFID tag,
(e) automatically reading in and checking the displayed response by the RFID reader.

2. The method according to claim 1, wherein
the computed response is displayed in encrypted form on the display.

3. The method according to claim 1, wherein
the computed response is displayed as a barcode on the display.

4. The method according to claim 1, wherein
a symmetric cryptographic method in which the RFID reader possesses the first secret key is used for the challenge-response protocol.

5. The method according to claim 1, wherein
an asymmetric cryptographic method having an asymmetric key pair consisting of a private and a public key is used for the challenge-response protocol, wherein the private key is known only to the RFID tag.

6. The method according to claim 5, wherein
the RFID reader possesses the public key of the asymmetric key pair.

7. The method according to claim 5, wherein
the public key is transmitted to the RFID reader in a certificate that is assigned to the RFID tag.

8. The method according to claim 7, wherein
the certificate transmitted by the RFID tag is checked by the RFID reader in order to verify its validity,
and the check on the validity of the certificate is performed using a further public key.

9. The method according to claim 5, wherein
the asymmetric cryptographic method is implemented on the basis of scalar multiplications on a suitable elliptic curve.

10. A system for authenticating an Radio Frequency Identification (RFID) tag by means of an RFID reader in accordance with a challenge-response protocol, the system comprising:
(a) an RFID reader which has a first authentication module for generating a challenge and for checking a received response, and which has a first communication module for wirelessly transmitting the challenge,
(b) at least one RFID tag, having a second communication module for receiving the transmitted challenge and a second authentication module which computes the response associated with the received challenge,
wherein
the RFID tag has a display on which the computed response is displayed and
the RFID reader has an optical reading module by means of which the displayed response is automatically read in.

11. The system according to claim 10, wherein
the RFID tag together with associated display is operated passively.

12. The system according to claim 10, wherein
the first and second authentication module have a computing module which is provided for performing calculations, checks and authentications within the respective authentication module.

13. The system according to claim 10, wherein
the first and second authentication module have an encryption/decryption device which is provided for performing at least one of a respective encryption and a decryption.

14. A Radio Frequency Identification (RFID) tag comprising:
wireless communication means,
means for computing a response on the basis of a wirelessly transmitted challenge and a first secret key that is assigned to the RFID tag,
a display for displaying the computed response, wherein the displayed response can be automatically read in and checked by an RFID reader.

15. The RFID tag according to claim 14, wherein
the computed response is displayed in encrypted form on the display.

16. The RFID tag according to claim 14, wherein
the computed response is displayed as a barcode on the display.

17. The RFID tag according to claim 14, wherein
a symmetric cryptographic method in which the RFID reader possesses the first secret key is used for a challenge-response protocol.

18. The RFID tag according to claim 14, wherein
an asymmetric cryptographic method having an asymmetric key pair consisting of a private and a public key is used for a challenge-response protocol, wherein the private key is known only to the RFID tag.

19. The RFID tag according to claim 18, wherein
the RFID reader possesses the public key of the asymmetric key pair.

20. The RFID tag according to claim 18, wherein
the public key is transmitted to the RFID reader in a certificate that is assigned to the RFID tag.
